(19) United States
(12) Patent Application Publication
(10) Pub. No.: US 2026/0274743 A1
(43) Pub. Date: Sep. 17, 2026

(54) GERMANATE GLASS-CERAMIC PRECIPITATING LILUF4 NANOCRYSTALS AND PREPARATION METHOD THEREOF

(71) Applicant: China Jiliang University, Hangzhou City (CN)

(72) Inventors: Lihui HUANG, Hangzhou City (CN); Junfei ZHOU, Hangzhou City (CN); Jingtao ZHAO, Hangzhou City (CN); Gongxun BAI, Hangzhou City (CN); Shilong ZHAO, Hangzhou City (CN); Shiqing XU, Hangzhou City (CN)

(21) Appl. No.: 19/430,379

(22) Filed: Dec. 23, 2025

(30) Foreign Application Priority Data
Mar. 12, 2025 (CN) 202510290361.2

(51) Int. Cl. C03C 10/16; C03B 25/02; C03B 32/02; C03C 4/12; C09K 11/02; C09K 11/77

(52) U.S. Cl. CPC C03C 10/16; C03B 25/02; C03B 32/02; C03C 4/12; C09K 11/02; C09K 11/7705

(57) ABSTRACT

A germanate glass-ceramic precipitating LiLuF₄ nanocrystals and a preparation method thereof are provided. The molar percentage composition of the glass-ceramic is: 40-50 mole percent (mol%) GeO₂, 10-15 mol% LiF, 10-15 mol% LuF₃, 10-20 mol% H₃BO₃, 5-10 mol% YF₃, and 10-15 mol% La₂O₃. The preparation method includes following steps: weighing a certain mass of high-purity raw materials according to the above molar percentages and mixing uniformly; melting in a lifting furnace at 1350-1450 degrees Celsius and holding for 15-45 minutes; pouring the glass melt into a mold and placing the glass melt in a muffle furnace for annealing at 400-500 degrees Celsius for 3-5 hours; naturally cooling to room temperature to obtain the base glass; heat treating the obtained base glass within a crystallization temperature range for 1-6 hours; and naturally cooling to room temperature to obtain the glass-ceramic precipitating LiLuF₄ nanocrystals.

### CROSS-REFERENCE TO RELATED APPLICATIONS

This application claims priority to Chinese Patent Application No. 202510290361.2, filed on Mar. 12, 2025, the contents of which are hereby incorporated by reference.

### TECHNICAL FIELD

The present disclosure relates to the field of rare-earth doped glass-ceramics, and specifically relates to a germanate glass-ceramic precipitating LiLuF₄ nanocrystals and a preparation method thereof.

### BACKGROUND

With the rapid development of optoelectronic information technology, transparent optical materials represented by rare-earth ion doped luminescent glass have been widely used in fields such as laser light sources, displays, luminescence, and medicine. In order to obtain luminescent materials with excellent luminescence properties and good environmental adaptability, it is required that the host material used for doping luminescence not only has low phonon energy, but also possesses good thermal, chemical stability and mechanical properties.

Glass-ceramic is a material between glass and crystal, combining the advantages of both. For oxyfluoride glass-ceramic, fluoride nanocrystals with low phonon energy are uniformly distributed in the oxide glass network, and rare-earth ions preferentially enrich into the fluoride crystal phase, which determines that the oxyfluoride glass-ceramic combines the advantages of both oxide glass and fluoride crystals. The oxyfluoride glass-ceramic has both low phonon energy and high chemical stability and mechanical stability.

Since the size of the precipitated fluoride nanocrystals is generally several tens of nanometers, which is much smaller than the wavelength of visible light, so the oxyfluoride glass-ceramic has high transmittance to visible light. Therefore, in recent years, the oxyfluoride glass-ceramic has gradually attracted attention and research interest.

### SUMMARY

In order to solve the above technical problems existing in the prior art, the present disclosure provides a germanate glass-ceramic precipitating LiLuF₄ nanocrystals and a preparation method thereof, specifically by designing the glass composition, obtaining a base glass through a melt-quenching method, and then heat treating the base glass to precipitate LiLuF₄ nanocrystals in the glass. The specific technical scheme is as follows.

A germanate glass-ceramic precipitating LiLuF₄ nanocrystals is provided. A glass has a molar percentage composition including: GeO₂ 40 to 50 mole percent (mol%), LiF 10 to 15 mol%, LuF₃ 10 to 15 mol%, H₃BO₃ 10 to 20 mol%, YF₃ 5 to 10 mol%, and La₂O₃ 10 to 15 mol%.

A preparation method for the germanate glass-ceramic precipitating LiLuF₄ nanocrystals, including following steps:
(1) preparing ingredients: using GeO2, LiF, LuF3, H3BO3, YF3, and La2O3 as raw materials for a glass composition, and weighing a corresponding mass of the raw materials according to a selected molar percentage of the glass composition described above, then grinding and mixing uniformly in a mortar;
(2) melting: pouring uniformly mixed glass raw materials into a crucible, and melting in a silicon carbide rod electric furnace;
(3) shaping: pouring a glass melt into a mold preheated to 400-500 degrees Celsius for shaping;
(4) annealing: placing a shaped glass into a muffle furnace for annealing, with an annealing temperature of 400-500 degrees Celsius and an annealing duration of 3 to 5 hours, then turning off a muffle furnace power and allowing the shaped glass to cool down to room temperature inside the muffle furnace;
(5) heat treating: performing heat treatment at a crystallization temperature range (600-650 degrees Celsius) for multiple hours; and
(6) polishing: cutting, grinding, and polishing a heat-treated glass to produce the germanate glass-ceramic precipitating the LiLuF4 nanocrystals.

In an embodiment, in the step (2), the melting temperature is 1350-1450 degrees Celsius, and the melting duration is 15-45 minutes.

In an embodiment, in the step (5), the crystallization temperature is 600-650 degrees Celsius.

The germanate glass-ceramic precipitating LiLuF₄ nanocrystals of the present disclosure has a simple and efficient preparation method, and has potential application prospects in fields such as optical communication, three-dimensional display, and solid-state lighting.

### BRIEF DESCRIPTION OF THE DRAWINGS

In order to more clearly illustrate the technical schemes in the embodiments of the present disclosure or the prior art, the drawings required for use in the embodiments will be briefly introduced below. Apparently, the drawings in the following description are only some embodiments of the present disclosure.

FIG. 1 is the X-ray diffraction (XRD) pattern of the base glass and the glass-ceramic in Embodiment 1.

FIG. 2 is a flow chart of the preparation method for the germanate glass-ceramic precipitating LiLuF₄ nanocrystals.

### DETAILED DESCRIPTION OF THE EMBODIMENTS

The present disclosure is further described below in conjunction with the accompanying drawings.

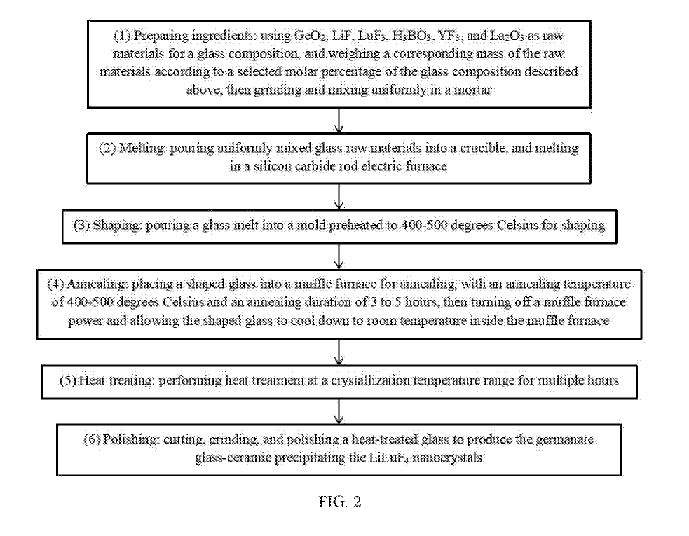

As shown in FIG. 2, the specific steps of the preparation method for the germanate glass-ceramic precipitating LiLuF₄ nanocrystals are presented in the following embodiments.

### Embodiment 1

According to the composition: 45GeO₂-12LiF-10LuF₃-15H₃BO₃-6YF₃-12La₂O₃ (mole percent (mol%)), the required GeO₂, LiF, LuF₃, H₃BO₃, YF₃, and La₂O₃ powder raw materials for a total mass of 20 grams are weighed, and they are placed in an agate mortar for full grinding and uniform mixing. The uniformly mixed glass raw materials are poured into a crucible, covered with a mullite lid, and placed in a silicon carbide rod electric furnace at 1400 degrees Celsius for melting for 45 minutes. Then the glass melt is quickly cast into a mold preheated to 500 degrees Celsius. After the glass is shaped, it is transferred to a muffle furnace at 500 degrees Celsius for annealing for 5 hours, and the base glass is obtained after natural cooling to room temperature. The obtained base glass is heated in the muffle furnace at a heating rate of 10 degrees Celsius per minute to 610 degrees Celsius and held for 3 hours to obtain the germanate glass-ceramic precipitating LiLuF₄ nanocrystals. The obtained glass-ceramic is cut, ground, and polished to produce a glass-ceramic with dimensions of 10 millimeters * 10 millimeters * 1.5 millimeters.

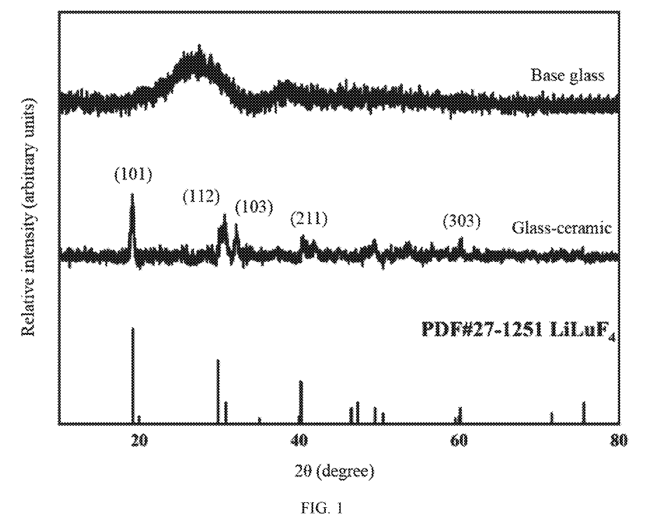

As shown in FIG. 1, the X-ray diffraction (XRD) patterns of the base glass and the glass-ceramic are displayed.

### Embodiment 2

According to the composition: 40GeO₂-15LiF-10LuF₃-15H₃BO₃-5YF₃-15La₂O₃ (mol%), the required GeO₂, LiF, LuF₃, H₃BO₃, YF₃, and La₂O₃ powder raw materials for a total mass of 20 grams are weighed, and they are placed in an agate mortar for full grinding and uniform mixing. The uniformly mixed glass raw materials are poured into a crucible, covered with a mullite lid, and placed in a silicon carbide rod electric furnace at 1350 degrees Celsius for melting for 25 minutes. Then the glass melt is quickly cast into a mold preheated to 400 degrees Celsius. After the glass is shaped, it is transferred to a muffle furnace at 500 degrees Celsius for annealing for 5 hours, and the base glass is obtained after natural cooling to room temperature. The obtained base glass is heated in the muffle furnace at a heating rate of 10 degrees Celsius per minute to 600 degrees Celsius and held for 4 hours to obtain the germanate glass-ceramic precipitating LiLuF₄ nanocrystals. The obtained glass-ceramic is cut, ground, and polished to produce a glass-ceramic with dimensions of 10 millimeters * 10 millimeters * 1.5 millimeters.

### Embodiment 3

According to the composition: 50GeO₂-10LiF-12LuF₃-11H₃BO₃-5YF₃-12La₂O₃ (mol%), the required GeO₂, LiF, LuF₃, H₃BO₃, YF₃, and La₂O₃ powder raw materials for a total mass of 20 grams are weighed, and they are placed in an agate mortar for full grinding and uniform mixing. The uniformly mixed glass raw materials are poured into a crucible, covered with a mullite lid, and placed in a silicon carbide rod electric furnace at 1450 degrees Celsius for melting for 30 minutes. Then the glass melt is quickly cast into a mold preheated to 500 degrees Celsius. After the glass is shaped, it is transferred to a muffle furnace at 500 degrees Celsius for annealing for 5 hours, and the base glass is obtained after natural cooling to room temperature. The obtained base glass is heated in the muffle furnace at a heating rate of 10 degrees Celsius per minute to 620 degrees Celsius and held for 3 hours to obtain the germanate glass-ceramic precipitating LiLuF₄ nanocrystals. The obtained glass-ceramic is cut, ground, and polished to produce a glass-ceramic with dimensions of 10 millimeters * 10 millimeters * 1.5 millimeters.

The above embodiments are used to explain and illustrate the present disclosure, rather than to limit it. Any modifications and changes made to the present disclosure within the spirit of the present disclosure and the protection scope of the claims fall into the protection scope of the present disclosure.

What is claimed is:

1. A germanate glass-ceramic precipitating LiLuF₄ nanocrystals, wherein a glass has a molar percentage composition comprising: GeO₂ 40 to 50 mole percent (mol%), LiF 10 to 15 mol%, LuF₃ 10 to 15 mol%, H₃BO₃ 10 to 20 mol%, YF₃ 5 to 10 mol%, and La₂O₃ 10 to 15 mol%.

2. A preparation method for the germanate glass-ceramic precipitating the LiLuF₄ nanocrystals according to claim 1, comprising following steps:
(1) preparing ingredients by using the GeO₂, the LiF, the LuF₃, the H₃BO₃, the YF₃ and the La₂O₃ as raw materials for a glass composition, and weighing a corresponding mass of the raw materials according to a selected molar percentage of the glass composition described above, then grinding and mixing uniformly in a mortar;
(2) melting by pouring uniformly mixed glass raw materials into a crucible, and melting in a silicon carbide rod electric furnace;
(3) shaping by pouring a glass melt into a mold preheated to 400-500 degrees Celsius for shaping;
(4) annealing by placing a shaped glass into a muffle furnace for annealing, with an annealing temperature of 400-500 degrees Celsius and an annealing duration of 3 to 5 hours, then turning off a muffle furnace power and allowing the shaped glass to cool down to room temperature inside the muffle furnace;
(5) heat treating by performing heat treatment at a crystallization temperature range for a plurality of hours; and
(6) polishing by cutting, grinding, and polishing a heat-treated glass to produce the germanate glass-ceramic precipitating the LiLuF₄ nanocrystals.

3. The preparation method according to claim 2, wherein in the step (2), a melting temperature is 1350-1450 degrees Celsius, and a melting duration is 15-45 minutes.

4. The preparation method according to claim 2, wherein in the step (5), a crystallization temperature is 600-650 degrees Celsius.
